(19) United States
(12) Patent Application Publication
(10) Pub. No.: US 2006/0102367 A1
(43) Pub. Date: May 18, 2006

(54) Pneumatically powered rotary tool having linear forward and reverse switch

(76) Inventors: Mark A. Etter, Humboldt, TN (US); Fredrick M. Morgan, Jackson, TN (US)

Correspondence Address: THE BLACK & DECKER CORPORATION, 701 EAST JOPPA ROAD, TW199, TOWSON, MD, 21286, US

(21) Appl. No.: 11/051,496

(22) Filed: Feb. 4, 2005

Related U.S. Application Data
(60) Provisional application No. 60/541,883, filed on Feb. 4, 2004.
(60) Provisional application No. 60/543,325, filed on Feb. 10, 2004.

(51) Int. Cl. B23B 45/04

(52) U.S. Cl. 173/218; 173/168

(57) ABSTRACT

A pneumatically powered rotary tool includes a linear forward and reverse switch assembly for alternatively setting the air motor of the tool to rotate the drive assembly of the tool in either of the clockwise direction or the counterclockwise direction. The switch assembly slides linearly along an axis generally perpendicular to the drive assembly between a first position for setting the air motor to rotate the drive assembly in the clockwise direction and a second position for setting the air motor to rotate the drive assembly in the counterclockwise direction. The switch assembly is positioned adjacent to the trigger so that the switch assembly can be slid between the first position and the second position by the index finger and thumb of the hand of the user gripping the handle portion without releasing the handle portion.

### CROSS-REFERENCE TO RELATED APPLICATIONS

The present application claims priority under 35 U.S.C. §119(e) to U.S. Provisional Application No. 60/541,883 entitled: User Friendly Air Power Tools filed Feb. 4, 2004 and U.S. Provisional Application No. 60/543,325 entitled: User Friendly Air Power Tools filed Feb. 10, 2004. The U.S. Provisional Applications, Ser. Nos. 60/541,883 and 60/543,325, are herein incorporated by reference in their entireties.

### FIELD OF THE INVENTION

The present invention generally relates to the field of pneumatically powered tools and, in particular, to a pneumatically powered rotary tools having a linearly actuated forward and reverse switch positioned adjacent to the tool's trigger for ease of operation.

### BACKGROUND OF THE INVENTION

Many pneumatically powered rotary tools, such as impact wrenches, air drills, air ratchets and the like, include a switch assembly which allows a user to both tighten and loosen fasteners, such as lug nuts or bolts by operating the tool in a forward or driving direction or a reverse or loosening direction. These switch assemblies usually have a first (forward) setting for tightening and a second (reverse) setting for loosening. While using the pneumatic tools, it may be necessary for a user to frequently switch the setting of the switch assembly from forward to reverse in order to tighten or loosen a plurality of bolts, screws, lug nuts and the like. Current pneumatic rotary tools include switch assemblies positioned on the tool housing so that they are distant from the trigger of the tool or wich are awkward to operate. Consequently, the user is forced to remove his had from the handle assembly or grip of the tool in order to change the switch assembly setting. Therefore, it would be advantageous to provide a pneumatically powered rotary tool such as an impact wrench, an air drill, an air ratchet, or the like having a linearly actuated forward and reverse switch positioned proximal to the tool's trigger for ease of operation by allowing the user to actuate the switch with the thumb and/or index finger of the hand holding the tool, without removing the hand from the handle assembly.

### SUMMARY OF THE INVENTION

Accordingly, the present invention is directed to pneumatically powered (i.e., air powered) rotary tool such as an impact wrench, an air drill, an air ratchet, or the like, having a linearly actuated forward and reverse switch positioned proximal to the tool's trigger for ease of operation by allowing the user to actuate the switch with the thumb and/or index finger of the hand holding the tool, without removing the hand from the handle assembly.

In an exemplary embodiment, the pneumatically-powered rotary tool includes a housing having a body portion and a handle portion. The handle portion extends from the body portion for being gripped by the hand of a user operating the pneumatically powered rotary tool. The tool includes a drive assembly at least substantially contained within the housing for rotating a chuck. An air motor coupled to the drive assembly rotates the drive assembly in both a clockwise direction and a counterclockwise direction. The tool further includes a trigger for causing the air motor to rotate the drive assembly. The trigger is positioned in the handle portion for actuation by the index finger of the hand of the user gripping the handle portion.

A linear switch assembly is provided for alternatively sets the air motor to rotate the drive assembly in the clockwise direction or the counterclockwise direction. The switch assembly slides linearly along an axis generally perpendicular to the drive assembly between a first position, for setting the air motor to rotate the drive assembly in the clockwise direction, and a second position, for setting the air motor to rotate the drive assembly in the counterclockwise direction. The switch assembly is positioned proximal or adjacent to the trigger so that the switch assembly can be slid between the first position and the second position by the index finger and/or the thumb of the hand of the user gripping the handle portion without releasing the handle portion.

In exemplary embodiments, the switch assembly includes a first actuator button and a second actuator button for setting the air motor to rotate the drive assembly in the clockwise direction or the counterclockwise direction. The first actuator button is positioned adjacent to the trigger in a first side of the housing and the second actuator button is positioned adjacent to the trigger in a second side of the housing opposite the first actuator button. The switch assembly slides along an axis generally perpendicular to the drive assembly between a first position, where the first actuator button is depressed and the second actuator button is not depressed for setting the air motor to rotate the drive assembly in the clockwise direction and a second position, where the second actuator button is depressed and the first actuator button is not depressed for setting the air motor to rotate the drive assembly in the counterclockwise direction.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is isometric view of a pneumatic tool including a linear switch assembly in accordance with an exemplary embodiment of the present invention, wherein the pneumatic tool is shown coupled with an air compressor;

FIG. 2 is an isometric view of the pneumatic tool shown in FIG. 1;

FIG. 3 is a front plan view of the pneumatic tool shown in FIG. 2;

FIG. 4 is an exploded isometric view of the pneumatic tool shown in FIG. 2; and

FIG. 5 is an isometric view of a pneumatic drill including a linear switch assembly in accordance with an exemplary embodiment of the present invention.

### DETAILED DESCRIPTION OF THE INVENTION

Reference will now be made in detail to the presently preferred embodiments of the invention, examples of which are illustrated in the accompanying drawings.

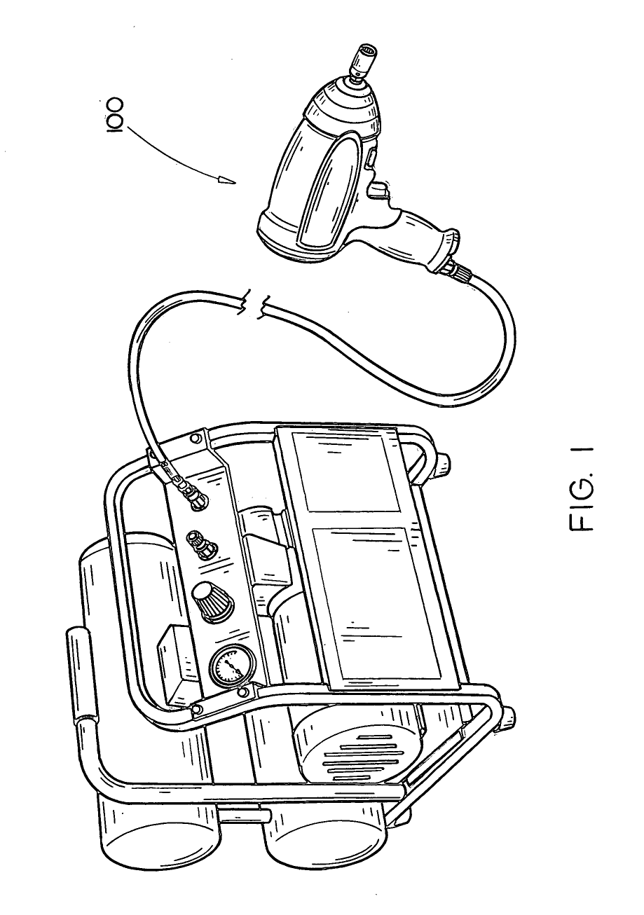

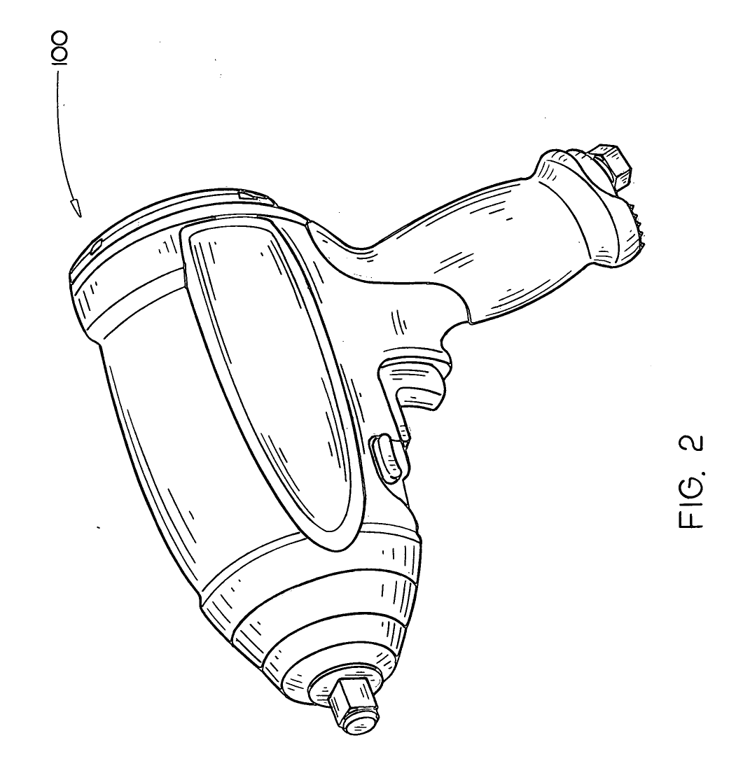

FIGS. 1 through 4 illustrates a pneumatically powered rotary tool, specifically a pneumatic impact wrench 100, having a linear forward and reverse switch assembly 102 in accordance with an exemplary embodiment of the present invention. As shown, the impact wrench 100 includes a housing 107 having a body portion 108 and a handle portion 110. The handle portion 110 extends from the body portion 108 for being gripped by the hand of a user operating the pneumatically powered impact wrench 100. The housing 107 may be at least partially coated with an elastomeric material 140 & 150 (e.g., plastic, rubber, synthetic rubber, or the like) for protecting the housing 107. In exemplary embodiments, this elastomeric material 140 may at least partially extend over the handle portion 110 for providing ease of grip of the handle portion 110 by the user.

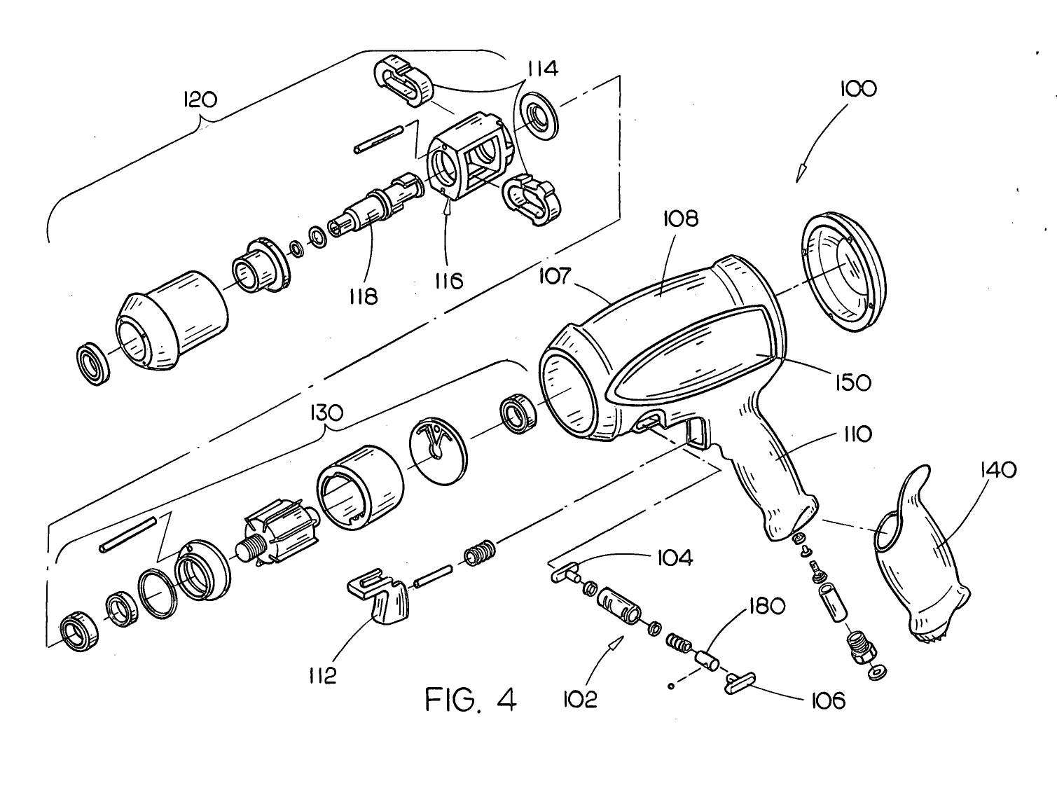

As shown in FIG. 4, the impact wrench 100 includes a drive assembly 120 supported within the body portion 108 of the housing 107 for rotating a chuck 118. In the embodiment illustrated, the drive assembly 120 includes a hammer assembly 116 for controlling torque provided to the chuck 118. An air motor 130, also contained within the body portion 108 of the housing 107 is coupled to the drive assembly 120 for rotating the drive assembly 120 in both a clockwise direction and a counterclockwise direction. A trigger 112 causes the air motor 130 to rotate the drive assembly 120. In exemplary embodiments, the trigger 112 is positioned in the handle portion 110 for actuation by the index finger of the hand of the user gripping the handle portion 110. In the present embodiment, the trigger 112 extends from the handle portion 110 substantially adjacent to the body portion 108 of the housing 107 so that the trigger 112 is positioned to be actuated by the index finger of a hand gripping the handle portion 110.

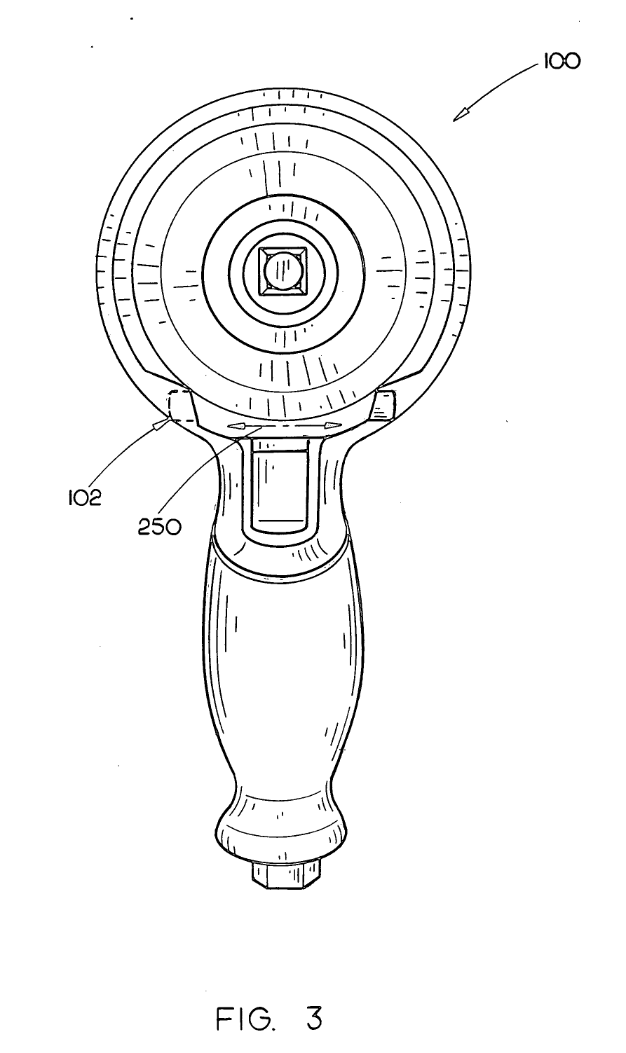

The switch assembly 102 sets the air motor 130 to rotate the drive assembly in the clockwise direction or the counterclockwise direction. In the present embodiment, the switch assembly 102 slides linearly (as shown in FIG. 3) along an axis 225 generally perpendicular to the drive assembly 120 between a first position and a second position. In the first position, the switch assembly 102 sets the air motor 130 to rotate the drive assembly 120 in the clockwise direction. In the second position, the switch assembly 102 sets the air motor 130 to rotate the drive assembly 120 in the counterclockwise direction. This is useful in that a user of the impact wrench may be allowed to selectively loosen or tighten, for example, a lug nut, by setting the switch assembly in the first or second position. The switch assembly 102 is positioned adjacent to the trigger 112 so that the switch assembly 102 may be slid between the first position and the second position by the index finger and thumb of the hand of the user gripping the handle portion 110 without releasing the handle portion 110. In the present embodiment, the switch assembly 102 includes a first actuator button 104 and a second actuator button 106 for setting the air motor 130 to rotate the drive assembly 120 in the clockwise direction or the counterclockwise direction. The first actuator button 104 is positioned adjacent to the trigger 112 in a first side of the housing and the second actuator button 106 is positioned adjacent to the trigger 112 in a second side of the housing 107 opposite the first actuator button 104. The switch assembly 102 slides along an axis 225 generally perpendicular to the drive assembly 120 between a first position where the first actuator button 104 is depressed and the second actuator button 106 is not depressed for setting the air motor 130 to rotate the drive assembly 120 in the clockwise direction and a second position where the second actuator button 106 is depressed and the first actuator button 104 is not depressed for setting the air motor 130 to rotate the drive assembly 120 in the counterclockwise direction. In an exemplary embodiment, the switch assembly 102 is positioned in the housing above and forward of the trigger 112 in relation to the handle portion 110.

In the present embodiment, the impact wrench 100 further includes a regulator 180 for regulating at least one of the amount and pressure of air provided to the air motor 130. The regulator 180 may be controlled by sliding the switch assembly 102 to at least a third position intermediate of the first position and the second position. For example, the first 104 and second 106 actuator buttons may be rotatably adjustable when the switch assembly 102 is in at least a third position intermediate of the first and second positions to regulate at least one of the amount and pressure of air provided to the air motor 130. The switch assembly 102 is positioned adjacent to the trigger 112 so that the switch assembly 102 may be slid between the first position and the second position by the index finger and thumb of the hand of the user gripping the handle portion 110 without releasing the handle portion 110.

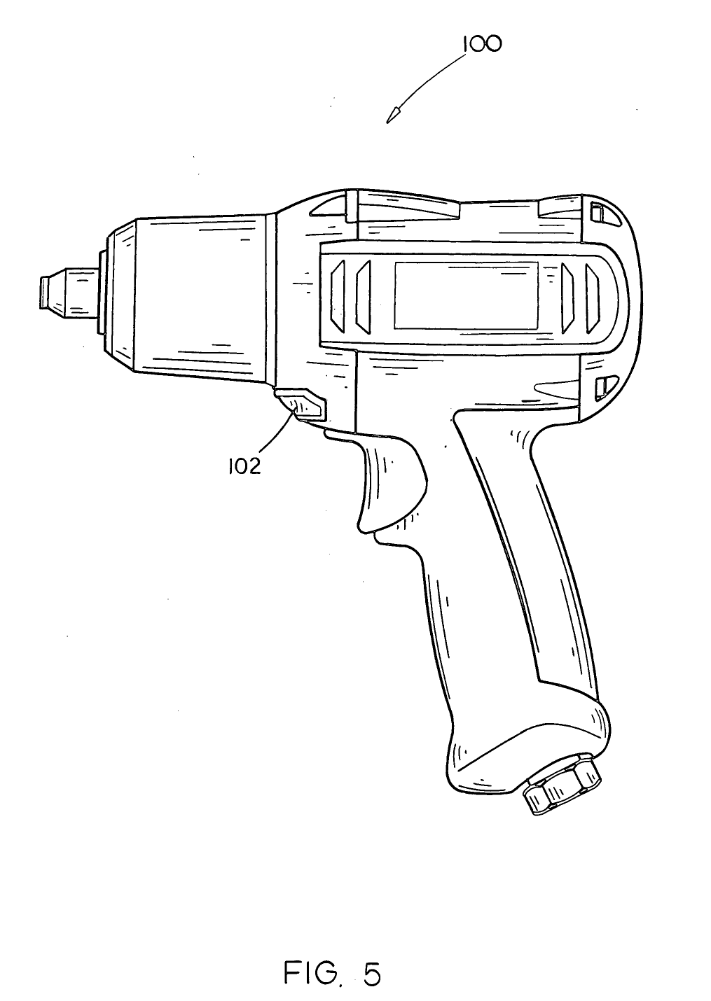

In a present embodiment, the pneumatically powered rotary tool comprises an impact wrench. However, it is contemplated by one of skill in the art that the pneumatically powered rotary tool may be an air drill, (as shown in FIG. 5) an air ratchet and the like without departing from the scope and spirit of the present invention.

It is believed that the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed is:

1. A pneumatically powered rotary tool, comprising:
a housing having a body portion and a handle portion, the handle portion extending from the body portion for being gripped by the hand of a user operating the pneumatically powered rotary tool;
a drive assembly at least substantially contained within the housing for rotating a chuck;
an air motor at least substantially contained within the housing and coupled to the drive assembly for rotating the drive assembly in both a clockwise direction and a counterclockwise direction;
a trigger for causing the air motor to rotate the drive assembly, the trigger being positioned in the handle portion for actuation by the index finger of the hand of the user gripping the handle portion; and
a switch assembly for alternatively setting the air motor to rotate the drive assembly in the clockwise direction or the counterclockwise direction, the actuator assembly sliding linearly along an axis generally perpendicular to the drive assembly between a first position for setting the air motor to rotate the drive assembly in the clockwise direction and a second position for setting the air motor to rotate the drive assembly in the counterclockwise direction;
wherein the switch assembly is positioned adjacent to the trigger so that the switch assembly can be slid between the first position and the second position by the index finger and thumb of the hand of the user gripping the handle portion without releasing the handle portion.

2. The pneumatically powered rotary tool as claimed in claim 1, wherein the switch assembly comprises a first actuator button and a second actuator button for setting the air motor to rotate the drive assembly in the clockwise direction or the counterclockwise direction, the first actuator button being positioned adjacent to the trigger in a first side of the housing and the second actuator button being positioned adjacent to the trigger in a second side of the housing opposite the first actuator button.

3. The pneumatically powered rotary tool as claimed in claim 2, wherein the first actuator button is depressed and the second actuator button is not depressed for setting the air motor to rotate the drive assembly in the clockwise direction and a second position where the second actuator button is depressed and the first actuator button is not depressed for setting the air motor to rotate the drive assembly in the counterclockwise direction.

4. The pneumatically powered rotary tool as claimed in claim 1, wherein the switch assembly is positioned in the housing above and forward of the trigger in relation to the handle portion.

5. The pneumatically powered rotary tool as claimed in claim 1, further comprising a regulator for regulating at least one of the amount and pressure of air provided to the air motor.

6. The pneumatically powered rotary tool as claimed in claim 5, wherein the switch assembly can be slid to at least a third position intermediate of the first position and the second position for controlling the regulator.

7. The pneumatically powered rotary tool as claimed in claim 1, wherein the drive assembly further comprises a hammer assembly for controlling torque provided to the chuck.

8. The pneumatically powered rotary tool as claimed in claim 1, wherein the housing is at least partially coated with an elastomeric material for protecting the housing.

9. The pneumatically powered rotary tool as claimed in claim 8, wherein the elastomeric material at least partially extends over the handle portion for providing ease of grip of the handle portion by the user.

10. A pneumatically powered rotary tool, comprising:
a housing having a body portion and a handle portion, the handle portion extending from the body portion for being gripped by the hand of a user operating the pneumatically powered-rotary tool;
a drive assembly at least substantially contained within the body portion of the housing for rotating a chuck;
an air motor at least substantially contained within the body portion of the housing and coupled to the drive assembly for rotating the drive assembly, the air motor being capable of rotating the drive assembly in both a clockwise direction and a counterclockwise direction;
a trigger for causing the air motor to rotate the drive assembly, the trigger extending from the handle portion substantially adjacent to the body portion so that the trigger is positioned to be actuated by the index finger of a hand gripping the handle portion; and
a switch assembly including a first actuator button and a second actuator button for setting the air motor to rotate the drive assembly in the clockwise direction or the counterclockwise direction, the first actuator button being positioned adjacent to the trigger in a first side of the housing and the second actuator button being positioned adjacent to the trigger in a second side of the housing opposite the first actuator button,
wherein the switch assembly slides along an axis generally perpendicular to the drive assembly between a first position where the first actuator button is depressed and the second actuator button is not depressed for setting the air motor to rotate the drive assembly in the clockwise direction and a second position where the second actuator button is depressed and the first actuator button is not depressed for setting the air motor to rotate the drive assembly in the counterclockwise direction.

11. The pneumatically powered rotary tool as claimed in claim 10, wherein the switch assembly is positioned in the housing above and forward of the trigger in relation to the handle portion.

12. The pneumatically powered rotary tool as claimed in claim 10, further comprising a regulator for regulating at least one of the amount and pressure of air provided to the air motor.

13. The pneumatically powered rotary tool as claimed in claim 12, wherein the switch assembly can be slid to at least a third position intermediate of the first position and the second position for controlling the regulator.

14. The pneumatically powered rotary tool as claimed in claim 10, wherein the drive assembly further comprises a hammer assembly for controlling torque provided to the chuck.

15. The pneumatically powered rotary tool as claimed in claim 10, wherein the housing is at least partially coated with an elastomeric material for protecting the housing, the elastomeric material at least partially extending over the handle portion for providing ease of grip of the handle portion by the user.

16. A pneumatically powered impact wrench, comprising:
a housing having a body portion and a handle portion, the handle portion extending from the body portion for being gripped by the hand of a user operating the pneumatically powered impact wrench;
a drive assembly at least substantially contained within the body portion of the housing for rotating a chuck;
an air motor at least substantially contained within the body portion of the housing and coupled to the drive assembly for rotating the drive assembly, the air motor being capable of rotating the drive assembly in both a clockwise direction and a counterclockwise direction;
a trigger for causing the air motor to rotate the drive assembly, the trigger extending from the handle portion substantially adjacent to the body portion so that the trigger is positioned to be actuated by the index finger of a hand gripping the handle portion; and
a switch assembly including a first actuator button and a second actuator button for setting the air motor to rotate the drive assembly in the clockwise direction or the counterclockwise direction, the first actuator button being positioned adjacent to the trigger in a first side of the housing and the second actuator button being positioned adjacent to the trigger in a second side of the housing opposite the first actuator button,
wherein the switch assembly slides along an axis generally perpendicular to the drive assembly between a first position where the first actuator button is depressed and the second actuator button is not depressed for setting the air motor to rotate the drive assembly in the clockwise direction and a second position where the second actuator button is depressed and the first actuator button is not depressed for setting the air motor to rotate the drive assembly in the counterclockwise direction.

17. The pneumatically powered impact wrench as claimed in claim 16, wherein the switch assembly is positioned in the housing above and forward of the trigger in relation to the handle portion.

18. The pneumatically powered impact wrench as claimed in claim 16, further comprising a regulator for regulating at least one of the amount and pressure of air provided to the air motor.

19. The pneumatically powered impact wrench as claimed in claim 18, wherein the switch assembly can be slid to at least a third position intermediate of the first position and the second position for controlling the regulator.

20. The pneumatically powered impact wrench as claimed in claim 16, wherein the drive assembly further comprises a hammer assembly for controlling torque provided to the chuck.
